(19) United States
(12) Patent Application Publication
(10) Pub. No.: US 2003/0137534 A1
(43) Pub. Date: Jul. 24, 2003

(54) Internet television and method for displaying text thereof

(75) Inventor: Joon Yong Hong, Kyonggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 10/346,096

(22) Filed: Jan. 17, 2003

(30) Foreign Application Priority Data
Jan. 21, 2002 (KR) P2002-3331

(51) Int. Cl. G09G 5/00

(52) U.S. Cl. 345/738

(57) ABSTRACT

An Internet television and a method for displaying a text thereof are disclosed. The method includes (a)displaying information input through an interface part connected to an external communication network on a screen of the Internet television; (b)separating the text selected by a user from the displayed information according to a user's request; (c)performing an OSD(On Screen Display) process to the separated text; and (d)displaying the text performed in the ODS process on the displayed information.

### This application claims the benefit of the Korean Application No. P2002-3331 filed on Jan. 21, 2002, which is hereby incorporated by reference.

### BACKGROUND OF THE INVENTION

1. Field of the Invention

The present invention relates to an Internet television, and more particularly, to a method for displaying a text thereof.

2. Discussion of the Related Art

With growth of an information age, the Internet, which can be used as the communication media for collecting information of various fields such as society, culture, economics and sports, occupies an important position in everyday life. Accordingly, the number of personal computers(PC) has been rapidly increased as the media using the Internet.

Also, Internet television receivers for enjoying both viewing of television broadcasting programs and an Internet service have been developed in accordance with the demands that television receivers should escape from unidirectional communication for simply receiving and viewing the television broadcasting programs and should be developed as bi-directional communication media capable of receiving and transmitting information. To cope with the growth of the information age, a steady development of the Internet TVs is required.

However, most of Internet Web Pages provided by the present Internet TV are suitable for the PC environment. Thus, if the Internet Web Page is displayed on the Internet TV, a text of the Web Page is not clear due to a resolution and a size of the Internet TV, so that it is hard to read the text on the Internet TV.

In order to overcome the aforementioned problem, an Internet TV that can expand and display a text of a Web Page through an expansion window, is provided. That is, if a user selects the text of a desired region among texts of the Web Page, the expansion window is overlapped on the displayed Web Page, and the text selected through the expansion window is expanded and displayed.

FIG. 1 is a block diagram illustrating a structure of a related art Internet television. Referring to FIG. 1, the related art Internet television is provided with an interface part 1, a video processing part 2, a display part 3 and a controlling part 4.

A method for displaying a text in the related art Internet television having the aforementioned structure will be explained as follows.

If a user selects a desired Web browser, a corresponding Web page is input from an external communication network through the interface part 1. The input Web Page is input to the video processing part 2, and the video processing part 2 processes the corresponding Web Page to be displayed on the display part 3. The corresponding Web Page output from the video processing part 2 is displayed on the display part 3 of the Internet TV so as to be provided to the user. After that, if the user selects one portion of the displayed Web Page, the controlling part 4 controls the video processing part 2 for displaying the selected portion of the Web Page after expanding the selected part of the Web Page at a predetermined ratio.

As shown in FIG. 2A, if the user selects the text desired to expand, the selected text is expanded at the predetermined ratio through the expansion window overlapped on the Web Page, and then the expanded text is displayed on the display part 3. At this time, if the selected text is long, the text is expanded with a movement of the expansion window, as shown in FIG. 2B. The movement of the expansion window is performed with movement keys of a remote control and a key panel.

However, the related art Internet television has the following disadvantages.

In the related art Internet television, the selected text is expanded as dot unit of a pixel, so that it is hard to read the text since the expanded text or image is not clear.

Also, if the text desired to expand is too long to be displayed on the display part, the user directly has to move the expansion window, thereby generating a user's inconvenience in using the Internet television.

### SUMMARY OF THE INVENTION

Accordingly, the present invention is directed to an Internet television and a method for displaying a text thereof that substantially obviates one or more problems due to limitations and disadvantages of the related art.

An object of the present invention is to provide an Internet television, in which clearness of letters and images in a displayed text is improved, thereby obtaining a user's convenience.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an Internet television includes an interface part connected to an external communication network; a text separating part separating a text from information input through the interface part; an OSD(On Screen Display) processing part performing an OSD process to the text separated from the text separating part; a video processing part processing information input through the interface part and the text performed in the ODS processing part to be displayed on a screen of the television part; and a controlling part controlling operations of the text separating part, the OSD processing part and the video processing part according to a user's input.

At this time, the text separating part includes a text finder finding a location of the text selected by the user from the information input through the interface part, a text analyzer analyzing the text selected by the user, and a text separator separating the analyzed text, and outputting the separated text divided to have the number of letters within a scope displayable on the screen.

Preferably, the text finder finds the location of the text by a location of a mouse pointer or a cursor among the user's inputs, and the text analyzer analyzes tags of HTML(Hypertext Markup Language) in the information selected by the user.

Preferably, the text separator separates the text between the tags in the HTML of the information selected by the user.

Preferably, the controlling part determines whether the text exists in the information selected by the user.

Also, the controlling part determines whether the number of letters in the text separated from the text separator is within the scope displayable on the screen so as to control the text separator for dividing the separated text to have the number of the letters displayable on the screen, or the controlling part determines whether the number of letters in the text, being performed in the OSD processing part, is within the scope displayable on the screen, thereby controlling the video processing part so as to scroll the text, performed in the OSD processing part, on the screen.

A method for displaying a text in an Internet television including a text separating part separating a text from information input through an interface part connected to an external communication network, and an OSD(On Screen Display) processing part performing an OSD process to the text separated from the text separating part, includes (a)displaying the information input through the interface part connected to the external communication network on a screen of the Internet television; (b)separating the text selected by a user from the displayed information according to a user's request; (c)performing an OSD(On Screen Display) process to the separated text; (d)displaying the text performed in the ODS process on the displayed information; (e)determining whether the user requests a release of the text display, (f)determining whether the user selects another text from the displayed information, if the user does not request the release of the text display, and (g)repeatedly performing following process steps including the step(e), if the user does not select another text.

In the step(e), the text display is completed if the user requests the release of the text display.

In the step(f), following process steps including the step(b) are repeatedly performed if the user selects another text.

The step(b) includes (aa)determining whether the user requests a text display, (bb)finding a location of the information selected by the user, if the user's request is the text display, (cc)analyzing the information selected by the user, (dd)determining whether the text exists in the analyzed information, (ee)separating the text, if the text exists in the analyzed information, (ff)determining whether the number of letters in the separated text is within a scope displayable on the screen, and (gg)dividing the separated text to have the number of letters being in the scope displayable on the screen, if it is impossible to display the separated text on the screen since the separated text has the number of letters more than the number of letters for being displayable on the screen.

In the step(aa), if the user's request is not the text display, following process steps including the step(aa) are repeatedly performed.

In the step(dd), if the text does not exist, the text display is completed.

In another aspect, a method for displaying a text in an Internet television including a text separating part separating a text from information input through an interface part connected to an external communication network, and an OSD(On Screen Display) processing part performing an OSD process to the text separated from the text separating part, includes (a)displaying the information input through the interface part connected to the external communication network on a screen of the Internet television; (b)separating the text selected by a user from the displayed information according to a user's request; (c)performing the OSD process to the separated text; (d)displaying the text performed in the OSD processing part on the displayed information; (e)determining whether the user requests a release of a text display; (f)determining whether the user selects another text from the displayed information, if the user requests the release of the text display; (g)determining whether the number of letters in the text, performed in the OSD processing part, is within a scope displayable on the screen, if the user does not select another text; and (h)scrolling the text, performed in the ODS processing part, on the screen, if the number of letters in the text being performed in the ODS processing part is within the scope displayable on the screen.

The step(b) includes (aa)determining whether the user requests the text display, (bb)fining a location of the information selected by the user, if the user's request is the text display, (cc)analyzing the information selected by the user, (dd)determining whether the text exists in the analyzed information, and (ee)separating the text, if the text exists in the analyzed information.

In the step(aa), if the user's request is not the text display, following process steps including the step(aa) are repeatedly performed.

In the step(dd), if the text does not exist, the text display is completed.

In the step(e), the text display is completed, if the user requests a release of the text display.

In the step(f), if the user selects another text, following process steps including the step(b) are repeatedly performed.

In the step(g), if the number of letters in the text, being performed in the OSD processing part, is within the scope displayable on the screen, following process steps including the step(e) are repeatedly performed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a structure of a related art Internet television;

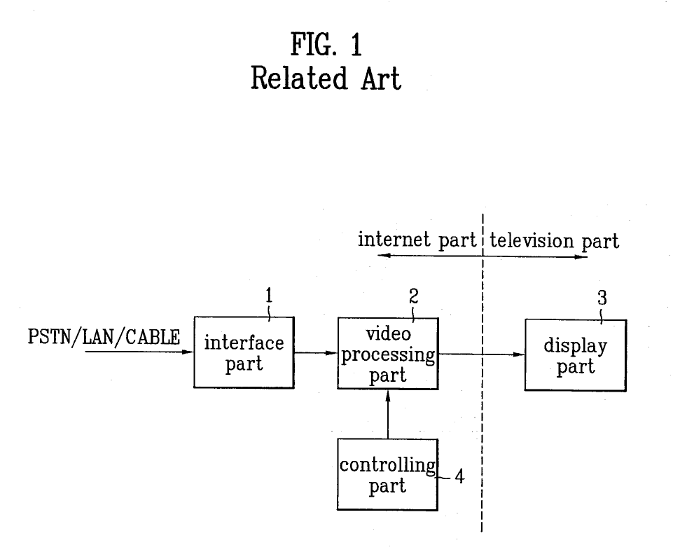

FIG. 2A is an exemplary view illustrating displaying of a text through an expansion window in a related art Internet television;

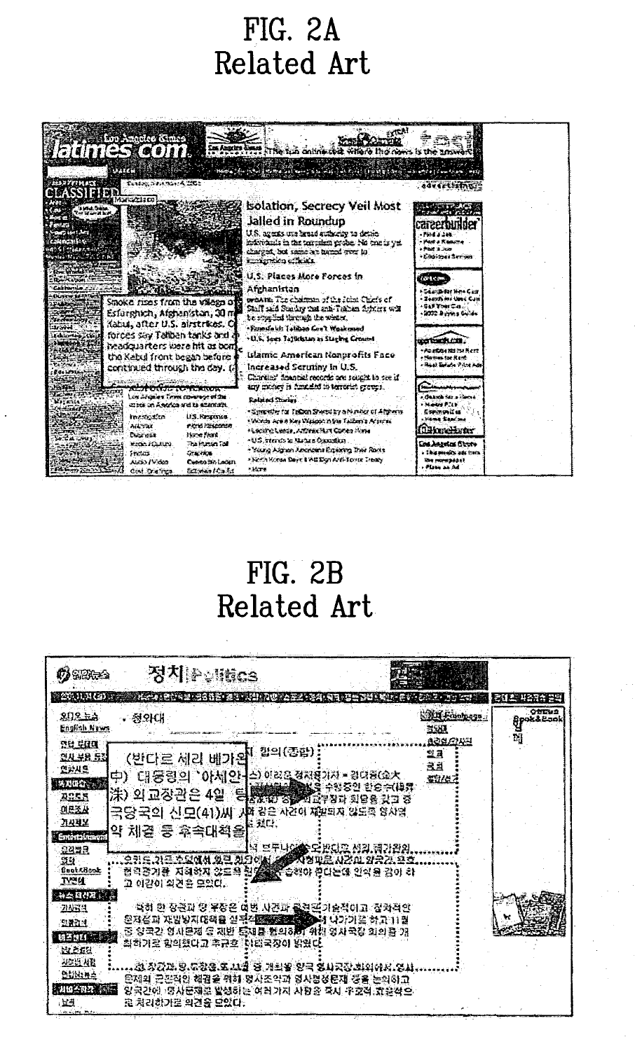

FIG. 2B is an exemplary view illustrating displaying of a text according to a movement of an expansion window in a related art Internet television;

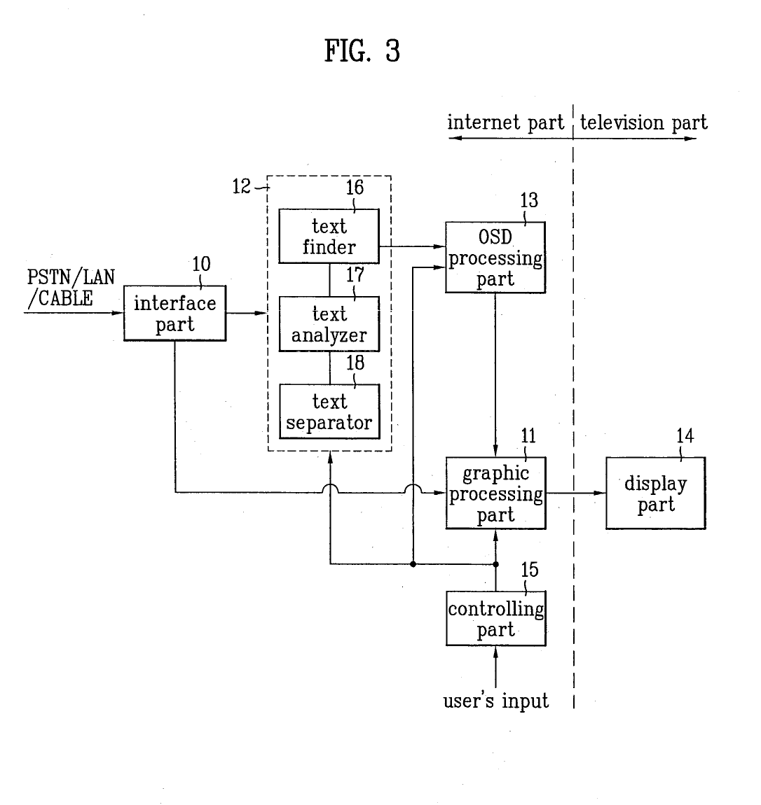

FIG. 3 is a block diagram illustrating a structure of an Internet television according to the present invention;

FIG. 4 is a flow chart illustrating a method for displaying a text in an Internet television according to the first embodiment of the present invention;

FIG. 5 is a flow chart illustrating a method for displaying a text in an Internet television according to the second embodiment of the present invention;

FIG. 6 is an exemplary view illustrating an Web Page displayed through an Internet television according to the present invention;

FIG. 7A to FIG. 7C are exemplary views illustrating HTML document structure of a Web Page;

FIG. 8A and FIG. 8B are exemplary views illustrating a mouse pointer location on a Web Page; and

FIG. 9 is an exemplary view illustrating a method for displaying a text in an Internet television according to the present invention, in which the text being performed in an OSD processing part scrolls on a Web Page.

### DETAILED DESCRIPTION OF THE INVENTION

Reference will now be made in detail to the preferred embodiments of the present invention, examples. of which are illustrated in the accompanying drawings. Wherever possible, the same reference numbers will be used throughout the drawings to refer to the same or like parts.

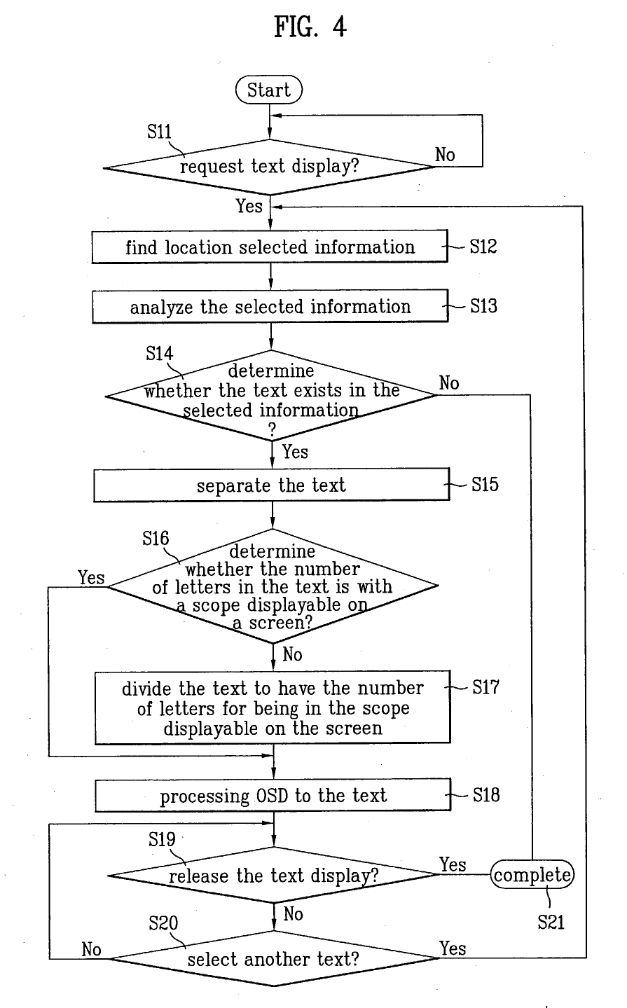

FIG. 3 is a block diagram illustrating a structure of an Internet television according to the present invention. Referring to FIG. 3, the Internet television according to the present invention is provided with a television part including a display part 14, and an Internet part including an interface part 10, a video processing part 11, a text separating part 12, an OSD (On Screen Display) processing part 13 and a controlling part 15.

At this time, the text separating part 12 is provided with a text finder 16, a text analyzer 17 and a text separator 18. The interface part 10 is connected to a Public Switched Telephone Network(PSTN) or a CABLE for being connected to an external communication network. Also, the text separating part 12 separates a text from source data of information such as a Web Page input through the interface part 10. The text finder 16 of the text separating part 12 finds a location of the text selected by a user from the source data of the Web Page input through the interface part 10. At this time, the user selects the text by a mouse pointer or a cursor, and the text finder 16 finds the location of the text by the mouse pointer or the cursor, the user's input.

Subsequently, the text analyzer 17 of the text separating part 12 analyzes the text of the Web Page selected by the user. In other words, the text analyzer 17 analyzes tags of Hypertext Markup Language(HTML) on the Web Page selected by the user. After that, the text separator 18 separates the analyzed text by separating the text between the tags in the HTML of the Web Page selected by the user. Also, the text separator 18 divides the text for having the number of letters to be in a scope displayable on a screen, and the divided text is output to the screen according to a control signal. The OSD processing part 13 performs an OSD process to the text separated from the text separating part 12.

Then, the video processing part 11 processes the information such as the Web Page input through the interface part 10, and the text processed in the OSD processing part 13, to be displayed on the screen of the television part. The controlling part 15 controls operations of the text separating part 12, the OSD processing part 13 and the video processing part 11 according to the user's input. That is, the controlling part 15 determines whether the number of letters in the text separated from the text separating part 12 is within a scope displayable on the screen. Then, the controlling part 15 controls the text separating part 12 for dividing the separated text to have the number of the letters displayable on the screen. Also, the controlling part 15 determines whether the text, being processed in the OSD processing part, has the number of letters more than the limited number of letters to be suitable for being displayed on the screen, thereby scrolling the text, processed in the OSD processing part, on the screen by controlling the video processing part 11.

A method of displaying the text in the Internet television having the aforementioned structure according to the present invention will be explained as follows.

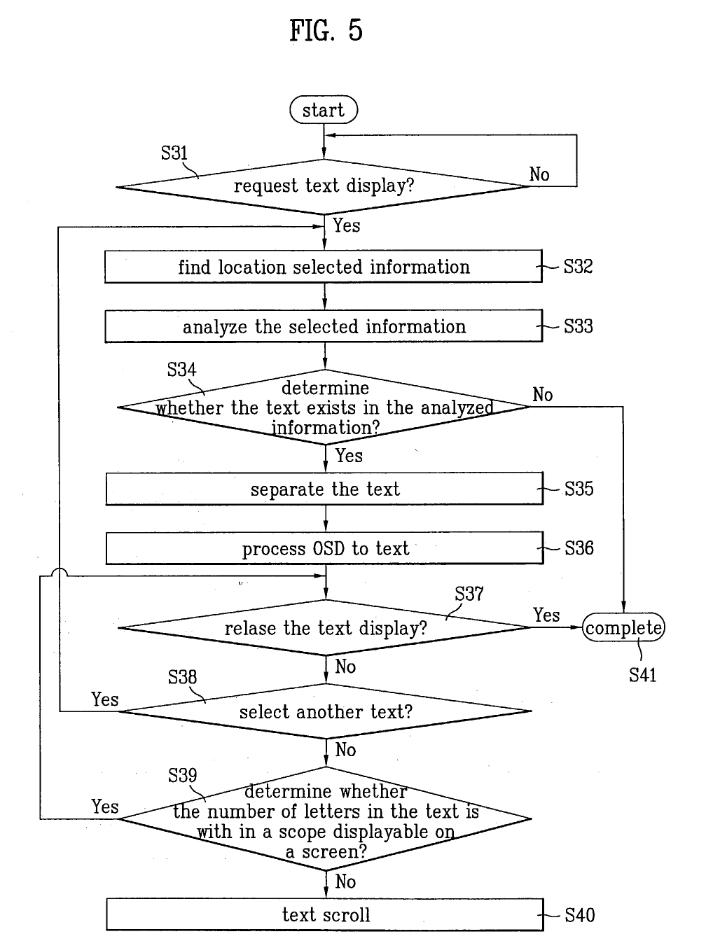

FIG. 4 is a flow chart illustrating a method for displaying a text in an Internet television according to the first embodiment of the present invention.

The Internet television according to the present invention provides a text display function on a menu, in which the text of the Web Page is expanded on the screen, and is displayed as On Screen Display(OSD). First, the Internet television displays information(Web Page) desired by the user on the screen through the interface connected to the external communication network. Then, the controlling part 15 determines whether the user requests the text display(S11). In a case of that the user requests the text display, the text finder 16 finds the location of the text selected by the user (S12).

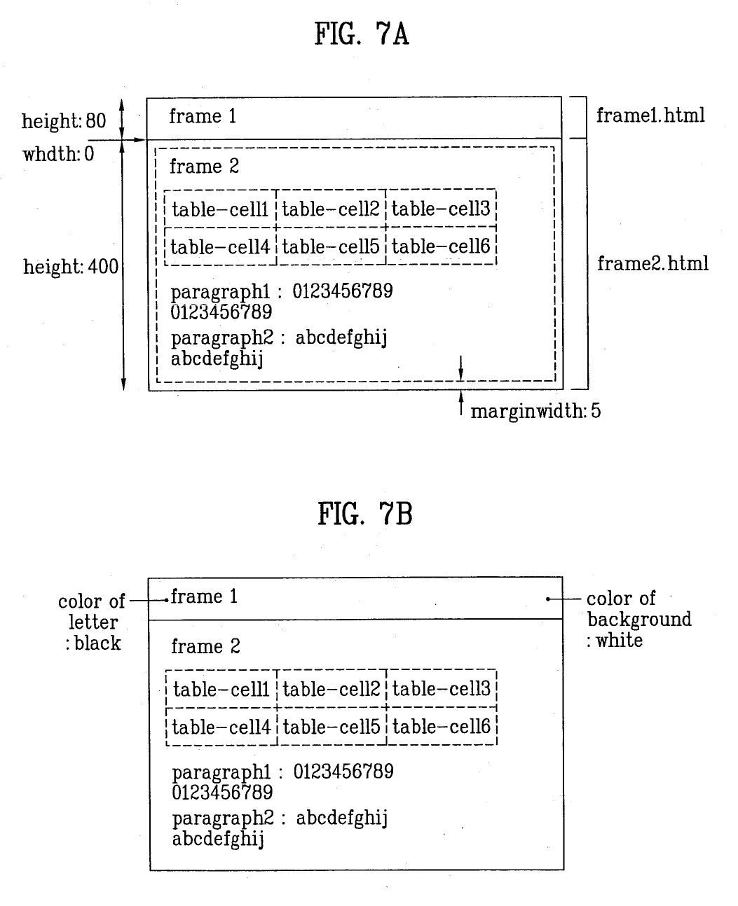

As shown in FIG. 6, the user selects the text by the mouse pointer or the cursor among the user's inputs, so that the text finder 16 finds the location of the text by the mouse pointer or the cursor. If the user does not request the text display, the aforementioned process step (S11) for determining whether the user requests the text display is repeatedly performed.

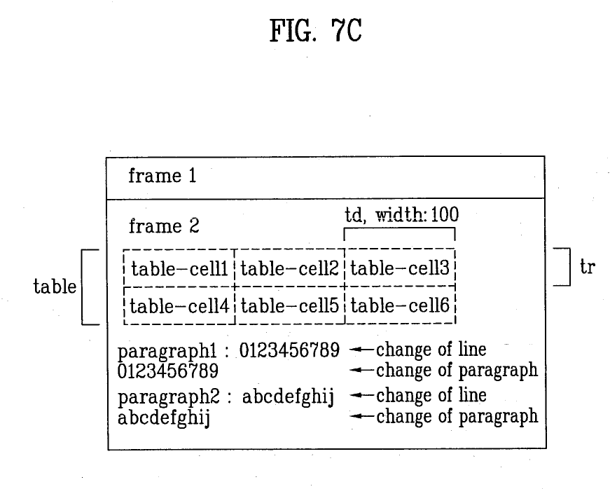

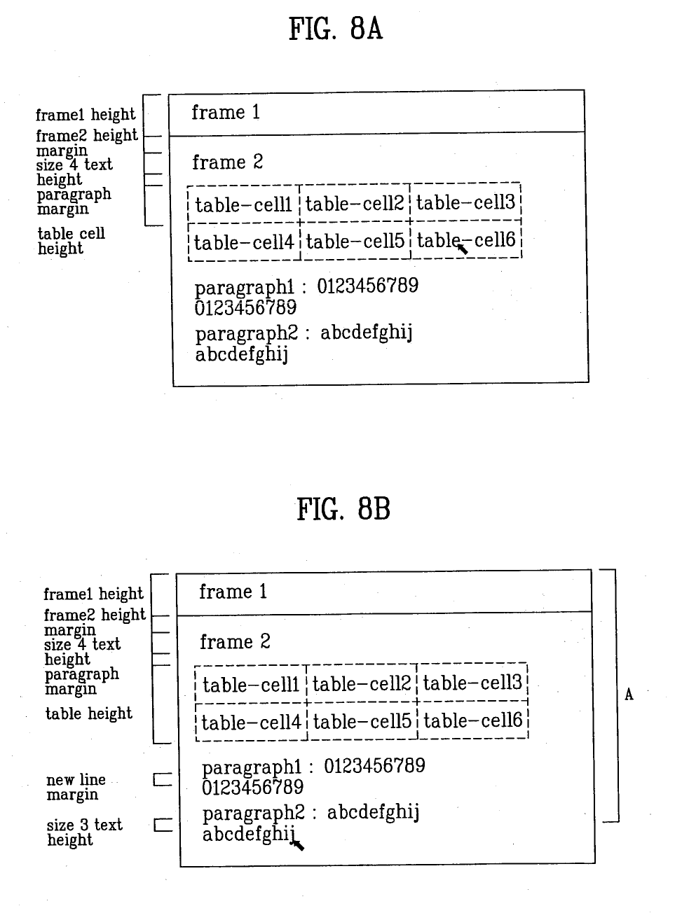

FIG. 7A to FIG. 7C are exemplary views illustrating HTML document structure of a Web Page. FIG. 8A and FIG. 8B are exemplary views illustrating a mouse pointer location on a Web Page. In FIG. 7A illustrating the HTML document structure, the source data is shown in following Table 1. According to Table 1, in a case of the HTML document using frames, the frames are arranged with <frameset> and <Frame> tags at the highest level. Table 1 is classified into a first frame and a second frame (frame1.html, frame2.html), in which a size of each frame, a margin between the frame and a real content, HTML document in each frame, a scroll state are shown.

TABLE 1

index.html
<html>
<head>
<title> It requires a browser for observing this page.
</title>
</head>
<frameset rows=“90px, 400px” border=“0”>

<frame src=“frame1.html” name=“frame1” scrolling=“no”

marginwidth=“5” marginheigth=“5”>

<frame src=“frame2.html” name=“frame2” scrolling=“no”

marginwidth=“5” marginheigth=“5”>
<noframes>
<body bgcolor=“white” text=“block” link=“blue” vlink=“purple” alink=“red”>
<p> It requires a browser for observing this page.(??)</p>
</body>
</noframes>
</frameset>
</html>

The following Table 2 shows HTML source data of the first frame, and the following Table 3 shows HTML source data of the second frame.

TABLE 2

frame1.html
<html>
<head>
<title>frame1</title>
<head>
<body bgcolor=“white” text=“block”>
<font zsize=“4”>frame 1<font>
</body>
</html>

In Table 2, colors of the letters and background in the whole document are determined in ‘<body>’ tag. The size of ‘<front>’ tag is from 1 to 7, and a basic value thereof is 3. A real size to each value is determined by the browser.

```
TABLE 3
frame2.html
<html>
<head>
<title>frame 2</title>
</head>
<body bgcolor=“white” text=“black”>
<font size=“4”>frame 2<font><p>
<table>
<tr>
  <td width=“100”>table-cell</td><td width=“100”>table-cell2</td><td
width=“100”>table-cell3</td>
</tr>
<tr>
  <td width=“100”>table-cell4</td><td width=“100”>table-cell5</td><td
width=“100”>table-cell6</td>
</tr>
</table><p>
paragraph1 : 01234567899<br>
01234567890<p>
paragraph2 : abcdefghij<br>
abcdefghij<p>
</body>
</html>
```

In Table 3, ‘<table> . . . </table>’ tag indicates start and end of the table, and ‘<tr> . . . </tr>’ tag indicates start and end of one line. Also, ‘<td> . . . </td>’ tag indicates one cell, and it is possible to set a size of cell corresponding to ‘<td>’, and a margin between the cell and the text. If a predetermined value is not set, a basic value of the browser is used. Furthermore, ‘<br>’ tag is used for changing a line of the text, and ‘<p>’ tag is used for changing a paragraph. At this time, a space between the lines of the text is determined according to the browser.

As explained in Table 1 to Table 3, the Web Pages provided in the Internet television are respectively made as HTML documents, thereby having the aforementioned source data. At this time, if the mouse pointer is located on a predetermined region of the table shown in FIG. 8A, the mouse pointer is located on the sixth cell (Cell 6) of the table according to following Table 4. Also, if the mouse pointer is located on a predetermined portion shown in FIG. 8B, the mouse pointer is located on a letter “i” portion of the last line according to Table 5.

TABLE 4
When the mouse pointer is located on (x, Y),
‘Y’ is,
(frame1 height)+(frame2 height margin)+(size 4 text height)+(paragraph
margin)+(table cell height) < Y < (frame 1 height)+(frame2 height
margin)+(size 4 text height)+(paragraph margin)+(table cell height)*2
‘X’ is,
(frame2 width margin)+(table cell width)*2 < X < (frame2 width
margin)+(table cell width)*3

TABLE 5
When the mouse pointer is located on (X, Y),
First,
A=(frame1 height)+(frame2 height margin)+(size 4 text height)+(table
height)+(paragraph margin)*3+(new line margin)*2+(size 3 text height)*3
‘Y’ is,
A < Y < A+(size3 text height)
‘X’ is,
(frame2 margin width)+(size 3 text width)*8 < X < (frame 2 marin
width)+(size 3 text width)8(

As explained above, the location of the mouse pointer is checked, and then the HTML document is analyzed, thereby finding the location of the texts selected by the user in the displayed information. Subsequently, the text analyzer 17 analyzes the texts selected by the user (S13). That is, the text analyzer 17 analyzes tags of the HTML selected by the user. At this time, the controlling part 15 determines whether the text exists within the information selected by the user (S14). If the text does not exist in the information selected by the user, the text display is completed (S21). Meanwhile, if the text exists in the information, the text separator 18 separates the text from the information (S15).

For example, as shown in FIG. 8A, if the mouse pointer is located on the sixth cell of the table, the text in ‘table-cell6’ is separated. However, if the mouse pointer is located on the letter ‘i’, the text ‘abcdefghij’ between the tags being adjacent to the letter ‘i’ is separated, as shown in FIG. 8B. Subsequently, the controlling part 15 determines whether the number of letters in the separated text is within a scope displayable on the screen (S16). If it is impossible to display the text on the screen since the separated text has the number of letters more than the number of letters to be suitable for being displayed on the screen, the controlling part 15 controls the text separator 18 to divide the separated text for being in the scope displayable on the screen (S17).

Then, the text output from the text separator 18 is processed in the OSD (On Screen Display) processing part 13 (S18). However, the number of the letters in the text separated from the controlling part 15 is displayable on the screen, the whole text is processed in the OSD processing part (S18). At this time, size and font of the text being processed in the OSD processing part are set as size and font according to a predetermined basic value of the OSD.

After that, the controlling part 15 determines whether the user requests a release of the text display (S19). If the release of the text display is requested, the controlling part 15 completes the text display (S21). However, if the user does not request the release of the text display, the controlling part 15 determines whether the user selects another text from the displayed information (S20). That is, the controlling part 15 determines whether the mouse pointer is moved. At this time, if the user does not select another text, the process step S19 is repeatedly performed. Meanwhile, if the user selects another text, the process step S12 is repeatedly performed.

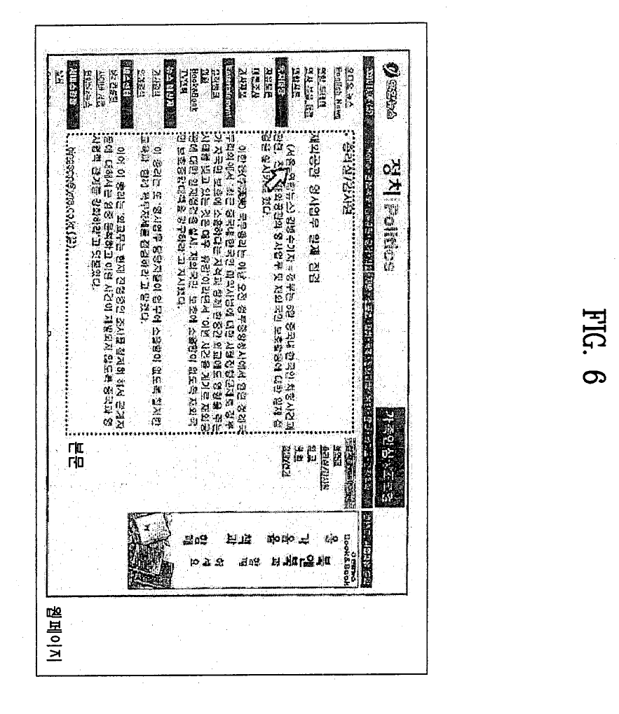

FIG. 5 is a flow chart illustrating a method for displaying a text in an Internet television according to second embodiment of the present invention. Process steps from S31 to S35 in the second embodiment of the present invention are same as process steps from S11 to S15 in the first embodiment of the present invention.

First, the text output from the text separator 18 is processed in the OSD (On Screen Display) processing part 13 (S36). Then, the controlling part 15 determines whether the user requests the release of the text display (S37). If the release of the text display is requested, the controlling part 15 completes the text display (S41). However, if the release of the text display is not requested, the controlling part 15 determines whether the user selects another text from the displayed information (S38). That is, the controlling part 15 determines whether the user moves the mouse pointer.

At this time, if the user selects another text, the process step S32 is repeatedly performed. However, if the user does not select another text, the controlling part 15 determines whether the number of letters in the separated text is within a scope displayable on the display part 14 (S39). That is, the controlling part 15 determines whether the separated text is long or not. If it is impossible to display the text on the screen since the separated text has the number of the letters more than the number of letters to be suitable for being displayed on the screen, the text, which is performed in the OSD processing part, scrolls on the display 14 (S40).

Herein, differences between the first and second embodiments of the present invention will be explained as follows.

In the first embodiment of the present invention, the controlling part 15 determines whether the number of letters in the text separated from the text separator 18 is within the scope displayable on the display part 14, thereby outputting the separated text in a state of being divided to be displayable on the display part 14. Meanwhile, in the second embodiment of the present invention, the controlling part 15 determines whether the number of letters in the text, being processed in the OSD processing part 13, is within the scope displayable on the display part 14, thereby controlling the video processing part 11 for scrolling the OSD processed text on the screen.

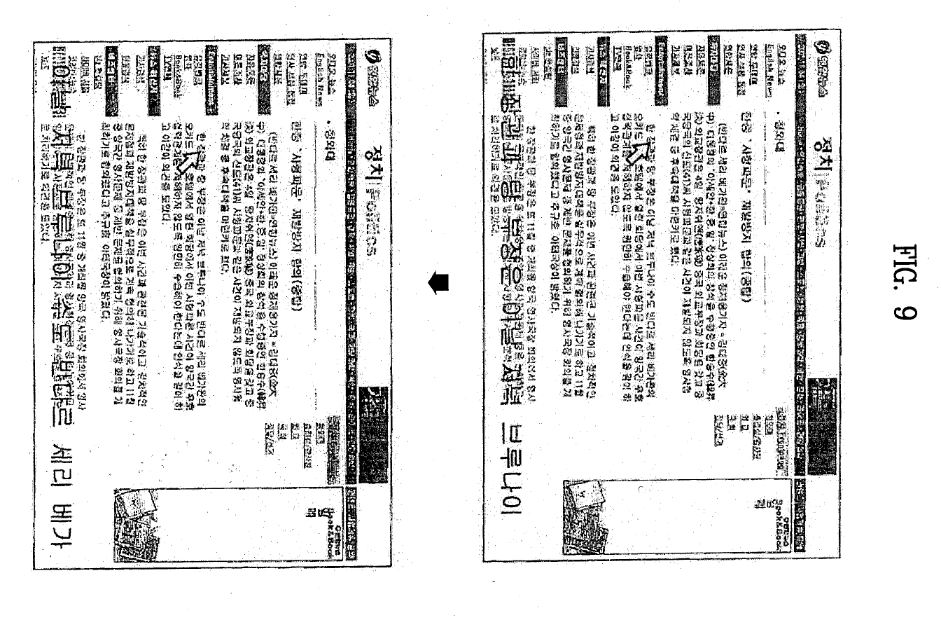

As shown in FIG. 9, the text, on which the mouse pointer is located, is separated, and then is processed on the OSD processing part, thereby displaying the OSD processed text for being scrolled at a lower portion of the screen.

In the related art, the expanded text is displayed with the movement of the expanded window. However, in the present invention, the text on which the mouse pointer is located is separated from the displayed information, and then the separated text is displayed. That is, the desired text of the Web Page is expanded, and is provided to the user, so that the text on which the mouse pointer is located is separated from the displayed information, thereby displaying the separated text on an OSD type.

Accordingly, the Internet television and the method for displaying the text thereof according to the present invention have the following advantages.

First, the text is separated from the displayed information, and the separated text is displayed on the OSD type, so that clearness of letters and images in a displayed text is improved.

Also, when the desired text is too long to display on the screen, the text scroll is possible without the user's input (mouse pointer or cursor), thereby obtaining a user's convenience.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An Internet television including a television part having a television broadcasting receiving function, and an Internet part having an Internet communication function, wherein the Internet part comprising:
an interface part connected to an external communication network;
a text separating part separating a text from information input through the interface part;
an OSD(On Screen Display) processing part performing an OSD process to the text separated from the text separating part;
a video processing part processing information input through the interface part and the text performed in the ODS processing part to be displayed on a screen of the television part; and
a controlling part controlling operations of the text separating part, the OSD processing part and the video processing part according to a user's input.

2. The Internet television as claimed in claim 1, wherein the text separating part comprising;
a text finder finding a location of the text selected by the user from the information input through the interface part,
a text analyzer analyzing the text selected by the user, and
a text separator separating the analyzed text, and outputting the separated text divided to have the number of letters within a scope displayable on the screen.

3. The Internet television as claimed in claim 2, wherein the text finder finds the location of the text by a location of a mouse pointer or a cursor among the user's inputs.

4. The Internet television as claimed in claim 2, wherein the text analyzer analyzes tags of HTML(Hypertext Markup Language) in the information selected by the user.

5. The Internet television as claimed in claim 2, wherein the text separator separates the text between the tags in the HTML of the information selected by the user.

6. The Internet television as claimed in claim 1, wherein the controlling part determines whether the text exists in the information selected by the user.

7. The Internet television as claimed in claim 1, wherein the controlling part determines whether the number of letters in the text separated from the text separator is within the scope displayable on the screen so as to control the text separator for dividing the separated text to have the number of the letters displayable on the screen, or the controlling part determines whether the number of letters in the text, being performed in the OSD processing part, is within the scope displayable on the screen, thereby controlling the video processing part so as to scroll the text, performed in the OSD processing part, on the screen.

8. A method for displaying a text in an Internet television including a text separating part separating a text from information input through an interface part connected to an external communication network, and an OSD(On Screen Display) processing part performing an OSD process to the text separated from the text separating part, comprising:
(a)displaying the information input through the interface part connected to the external communication network on a screen of the Internet television;
(b)separating the text selected by a user from the displayed information according to a user's request;
(c)performing an OSD(On Screen Display) process to the separated text; and
(d)displaying the text performed in the ODS process on the displayed information.

9. The method as claimed in claim 8, wherein the step(b) comprising;
(aa)determining whether the user requests a text display,
(bb)finding a location of the information selected by the user, if the user's request is the text display,
(cc)analyzing the information selected by the user,
(dd)determining whether the text exists in the. analyzed information, and
(ee)separating the text, if the text exists in the analyzed information.

10. The method as claimed in claim 9, further comprising;
(ff)determining whether the number of letters in the separated text is within a scope displayable on the screen, and
(gg)dividing the separated text to have the number of letters being in the scope displayable on the screen, if it is impossible to display the separated text on the screen since the separated text has the number of letters more than the number of letters for being displayable on the screen.

11. The method as claimed in claim 9, wherein, in the step(aa), if the user's request is not the text display, following process steps including the step(aa) are repeatedly performed.

12. The method as claimed in claim 9, wherein, in the step(dd), if the text does not exist, the text display is completed.

13. The method as claimed in claim 9, wherein, in the step(ff), if the number of letters in the separated text is within the scope displayable on the screen, following process steps including the step(c) are repeatedly performed.

14. The method as claimed in claim 8, further comprising;
(e)determining whether the user requests a release of the text display,
(f)determining whether the user selects another text from the displayed information, if the user does not request the release of the text display, and
(g)repeatedly performing following process steps including the step(e), if the user does not select another text.

15. The method as claimed in claim 14, wherein, in the step(e), the text display is completed if the user requests the release of the text display.

16. The method as claimed in claim 14, wherein, in the step(f), following process steps including the step(b) are repeatedly performed if the user selects another text.

17. A method for displaying a text in an Internet television including a text separating part separating a text from information input through an interface part connected to an external communication network, and an OSD(On Screen Display) processing part performing an OSD process to the text separated from the text separating part, comprising:
(a)displaying the information input through the interface part connected to the external communication network on a screen of the Internet television;
(b)separating the text selected by a user from the displayed information according to a user's request;
(c)performing the OSD process to the separated text;
(d)displaying the text performed in the OSD processing part on the displayed information;
(e)determining whether the user requests a release of a text display;
(f)determining whether the user selects another text from the displayed information, if the user requests the release of the text display;
(g)determining whether the number of letters in the text, performed in the OSD processing part, is within a scope displayable on the screen, if the user does not select another text; and
(h)scrolling the text, performed in the ODS processing part, on the screen, if the number of letters in the text being performed in the ODS processing part is within the scope displayable on the screen.

18. The method as claimed in claim 17, wherein the step(b) comprising;
(aa)determining whether the user requests the text display,
(bb)fining a location of the information selected by the user, if the user's request is the text display,
(cc)analyzing the information selected by the user,
(dd)determining whether the text exists in the analyzed information, and
(ee)separating the text, if the text exists in the analyzed information.

19. The method as claimed in claim 18, wherein, in the step(aa), if the user's request is not the text display, following process steps including the step(aa) are repeatedly performed.

20. The method as claimed in claim 18, wherein, in the step(dd), if the text does not exist, the text display is completed.

21. The method as claimed in claim 17, wherein, in the step(e), the text display is completed, if the user requests a release of the text display.

22. The method as claimed in claim 17, in the step(f), if the user selects another text, following process steps including the step(b) are repeatedly performed.

23. The method as claimed in claim 17, wherein, in the step(g), if the number of letters in the text, being performed in the OSD processing part, is within the scope displayable on the screen, following process steps including the step(e) are repeatedly performed.
